(19) United States
(12) Patent Application Publication
(10) Pub. No.: US 2016/0117044 A1
(43) Pub. Date: Apr. 28, 2016

(54) CONTROL MECHANISM FOR TOUCH DISPLAY APPARATUS

(71) Applicant: InnoLux Corporation, Miao-Li County (TW)

(72) Inventor: Tsan-Po WENG, Miao-Li County (TW)

(21) Appl. No.: 14/919,804

(22) Filed: Oct. 22, 2015

(30) Foreign Application Priority Data
Oct. 28, 2014 (TW) 103137139

(51) Int. Cl. G06F 3/041; G06F 3/044

(52) U.S. Cl. CPC G06F 3/0416; G06F 3/0412; G06F 3/044; G06F 2203/04107; G06F 2203/04103; G06F 2203/04112

(57) ABSTRACT

A touch display apparatus is provided. The touch display apparatus includes: a touch display panel and a controller. The touch display panel includes a plurality of sensing electrodes, wherein the plurality of sensing electrodes have a plurality of transmitting (Tx) electrodes and a plurality of receiving (Rx) electrodes. The controller is configured to control the touch display panel and the controller the controller alternately switches the Tx electrodes and the Rx electrodes to couple to the ground or high impedance using a first control path and a second control path, wherein the first control path controls the odd-numbered portion of the Tx electrodes and Rx electrodes, and the second control path controls the even-numbered portion of the Tx electrodes and Rx electrodes.

### CROSS REFERENCE TO RELATED APPLICATIONS

This Application claims priority of Taiwan Patent Application No. 103137139, filed on Oct. 28, 2014, the entirety of which is incorporated by reference herein.

### BACKGROUND OF THE INVENTION

1. Field of the Invention

The present invention relates to a touch display apparatus, and, in particular, to a touch display apparatus and an associated touch display detection method capable of alternately switching between different control paths for grounding or shielding, thereby reducing the number of touch control output pins.

2. Description of the Related Art

With advances in technology, mobile devices having touch functionality, such as smartphones and tablet PCs, have become more and more popular. In addition, the size of these mobile devices has also become bigger and bigger. Thus, the number of touch control output pins of the touch display panel has increased accordingly, resulting in a lower yield in manufacturing flexible printed circuits and a higher cost of the touch display panel. Accordingly, a touch display apparatus capable of significantly reducing the number of touch control output pins is needed, thereby increasing the yield for manufacturing the touch display apparatus and lowering the cost.

### BRIEF SUMMARY OF THE INVENTION

A detailed description is given in the following embodiments with reference to the accompanying drawings.

In an exemplary embodiment, a touch display apparatus is provided. The touch display apparatus includes: a touch display panel and a controller. The touch display panel includes a plurality of sensing electrodes, wherein the plurality of sensing electrodes have a plurality of transmitting (Tx) electrodes and a plurality of receiving (Rx) electrodes. The controller is configured to control the touch display panel and the controller the controller alternately switches the Tx electrodes and the Rx electrodes to couple to the ground or high impedance using a first control path and a second control path.

In another exemplary embodiment, a touch display detection method for use in a touch display apparatus is provided. The touch display apparatus comprises a controller and a plurality of sensing electrodes. The plurality of sensing electrodes comprise a plurality of transmitting (Tx) electrodes and a plurality of receiving (Rx) electrodes. The method comprises the steps of: utilizing the controller to control the sensing electrodes; and alternately switching the Tx electrodes and the Rx electrodes to couple to the ground or high impedance using a first control path and a second control path.

### BRIEF DESCRIPTION OF THE DRAWINGS

The present invention can be more fully understood by reading the subsequent detailed description and examples with references made to the accompanying drawings, wherein:

FIG. 1 is a block diagram of a touch display apparatus in accordance with an embodiment of the invention;

FIG. 2 is a diagram of the sensing array of a conventional touch display panel;

FIG. 3 is a diagram of a sensing array in accordance with an embodiment of the invention;

FIG. 4A is a diagram of a conventional sensing array;

FIG. 4B is a diagram of the sensing array in accordance with another embodiment of the invention;

FIG. 5A is a diagram of the detailed control paths in accordance with the embodiment of FIG. 3;

FIG. 5B is a diagram of the isolation paths in accordance with the embodiment of FIG. 5A;

FIG. 5C is a diagram of the control timing of each path in accordance with the embodiment of FIG. 5A;

FIG. 6 is a diagram illustrating the method of determining a touch position according to the detection signal from the sensing electrodes in accordance with an embodiment of the invention; and

FIG. 7 is a flow chart of a touch display detection method in accordance with an embodiment of the invention.

### DETAILED DESCRIPTION OF THE INVENTION

The following description is of the contemplated mode of carrying out the invention. This description is made for the purpose of illustrating the general principles of the invention and should not be taken in a limiting sense. The scope of the invention is determined by reference to the appended claims.

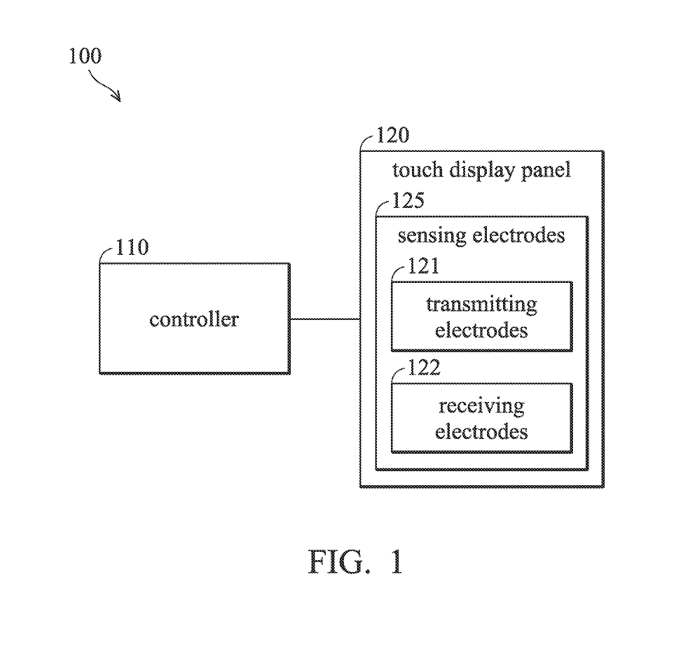

FIG. 1 is a block diagram of a touch display apparatus in accordance with an embodiment of the invention. As shown in FIG. 1, the touch display apparatus 100 comprises a controller 110 and a touch display panel 120. The touch display panel 120 is a single-layer touch display panel which comprises a sensing array 125 having a plurality of sensing electrodes such as transmitting (Tx) electrodes 121 and receiving (Rx) electrodes 122, wherein the Rx electrodes are implemented by capacitive sensors, but the invention is not limited thereto. The controller 110 sequentially controls the charging of the Tx electrodes 121 of the sensing array 125. When the user's hand or finger touches the touch display panel 120, the Rx electrodes 122 around the touch position may detect changes of the capacitance values and report the changes to the controller 110. The controller 110 may determine the position of the Rx electrodes 122 which have changes in capacitance values, thereby determining the touch position.

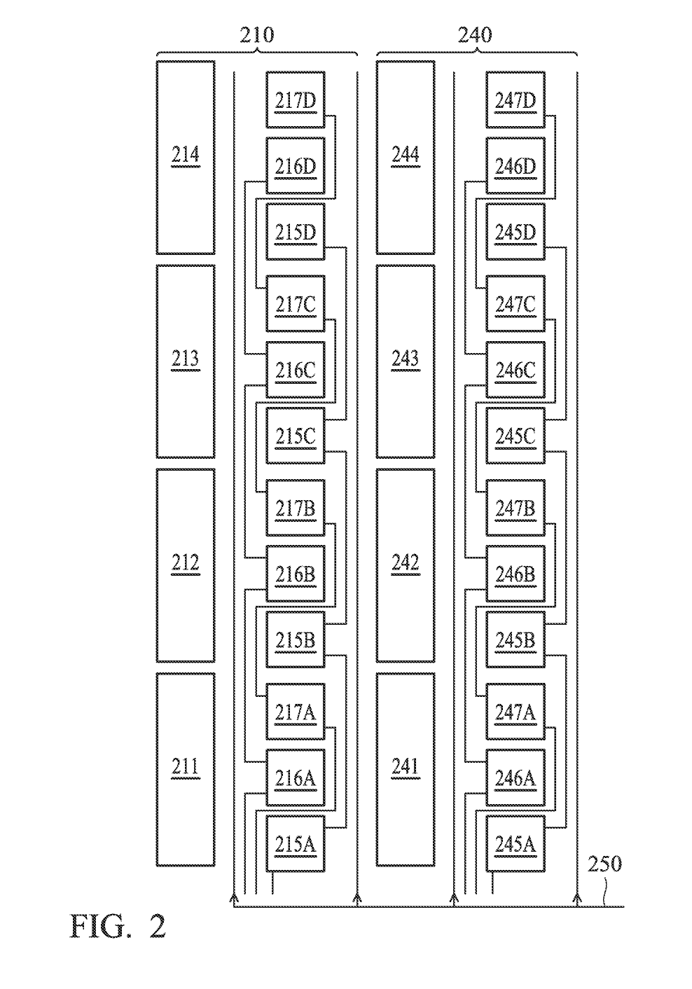

FIG. 2 is a diagram of the sensing array of a conventional touch display panel. As shown in FIG. 2, the sensing array 200 of the conventional touch display panel comprises a plurality of sensing electrodes such as electrodes 210 and 240. For example, the sensing electrodes 210 comprise Tx electrodes 211˜214 (i.e. a Tx electrode array) and Rx electrodes 215A˜215D, 216A˜216D, and 217A˜217D (i.e. an Rx electrode array). The electrodes 240 comprise Tx electrodes 241˜244 and Rx electrodes 245A˜245D, 246A˜246D, and 247A˜247D. The Rx electrodes 215A, 216A, and 217A correspond to the Tx electrode 211. That is, the Rx electrodes 215A, 216A, and 217A may detect the change of capacitance values around the Tx electrode 211. Similarly, the Rx electrodes 245A, 246A, and 247A correspond to the Tx electrode 241, and the Rx electrodes 245A, 246A, and 247A may detect the change of capacitance values around the Tx electrode 241. It should be noted that there are only two electrodes shown in FIG. 2 for brief description. There is a grounding path 250 between each column of Tx sensing array and Rx sensing array, and the controller may direct the grounding path 250 to the ground according to the refresh rate of the screen displayed on the touch display panel.

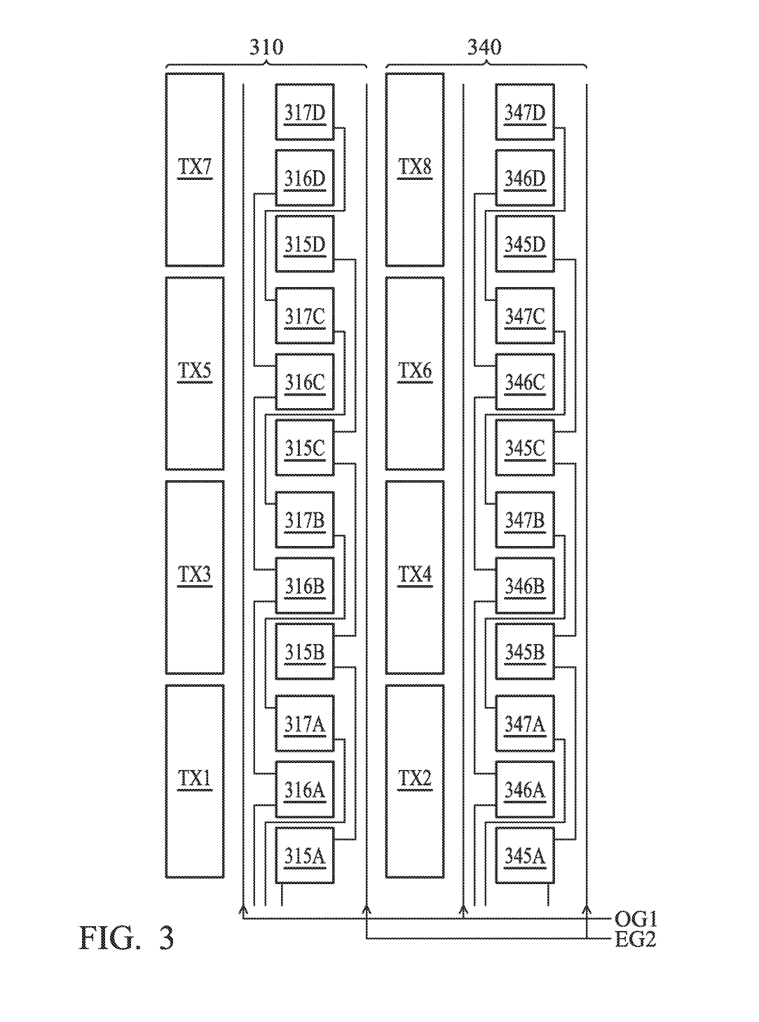

FIG. 3 is a diagram of a sensing array in accordance with an embodiment of the invention. As shown in FIG. 3, the sensing array 125 comprises a plurality of sensing electrodes (e.g. sensing electrodes 310 and 340) and a plurality of control paths (e.g. OG1 and EG2). The sensing electrodes 310 comprise Tx electrodes TX1, TX3, TX5, and TX7 (i.e. a Tx electrode array) and Rx electrodes 315A˜315D, 316A˜316D, and 317A˜317D (i.e. a Rx electrode array). The sensing electrodes 340 comprise Tx electrodes TX2, TX4, TX6, and TX8 (i.e. a Tx electrode array) and Rx electrodes 318A˜318D, 319A˜319D, and 320A˜320D (i.e. a Rx electrode array).

The control paths OG1 and EG2 control the substrate of the Tx electrode and Rx electrode in different sensing electrodes to couple to the ground or high impedance, respectively. When the substrate of the Tx electrode and the Rx electrode is coupled to the ground, it indicates that the detection function of the corresponding Tx electrode and Rx electrode are turned off When the substrate of the Tx electrode and the Rx electrode is coupled to high impedance, the electric charges at the Tx electrode can be transmitted to the Rx electrode, and it indicates that the Rx electrode may normally detect the change of capacitance values. Specifically, the control paths OG1 and EG2 can be regarded as an odd isolation path and an even isolation path, respectively. The odd isolation path (OG1) controls odd-numbered sensing electrodes, and the even isolation path (EG2) controls even-numbered sensing electrodes. When the control path OG1 is coupled to the ground, the control path EG2 is coupled to high impedance. When the control path OG1 is coupled to high impedance, the control path EG2 is coupled to the ground.

The Rx electrodes 215A, 216A, and 217A correspond to the Tx electrodes TX1 and TX2. That is, the Rx electrodes 215A, 216A, and 217A may detect the change of capacitance values at different positions around the Tx electrodes TX1 and TX2. Similarly, the Rx electrodes 215B, 216B, and 217B correspond to the Tx electrode TX3 and TX4. That is the Rx electrodes 215B, 216B, and 217B may detect the change of capacitance values at different position around the Tx electrodes TX3 and TX4. Specifically, although the TX electrodes TX1 and TX2 share the same Rx electrodes 215A, 216A, and 217A, they do not use the Rx electrodes 215A, 216A, and 217A simultaneously. For example, if the control path OG1 is coupled to the ground and the control path EG2 is coupled to high impedance, the electric charges on the Tx electrode TX1 cannot be transmitted to the Rx electrodes 215A, 216A, and 217A, but the electrical charges on the Tx electrode TX2 can be transmitted to the Rx electrodes 215A, 216A, and 217A. That is, the Rx electrodes 215A, 216A, and 217A may detect the change of capacitance values at the Tx electrodes TX2 at this time.

Conversely, if the control path EG2 is coupled to the ground and the control path OG1 is coupled to high impedance, the electric charges on the Tx electrode TX2 cannot be transmitted to the Rx electrodes 215A, 216A, and 217A, but the electric charges on the Tx electrode TX1 can be transmitted to the Rx electrodes 215A, 216A, and 217A. That is, the Rx electrodes 215A, 216A, and 217 may detect the change of capacitance values at the Tx electrode TX at this time. Specifically, compared with the conventional sensing array structure shown in FIG. 2, the RX electrodes in the sensing array shown in FIG. 3 can be implemented with double-sized sensing electrodes, and two neighboring Tx electrodes of the Rx electrode can be switched to couple to the ground and high impedance via the control paths OG1 and EG2, thereby sharing the same Rx electrode.

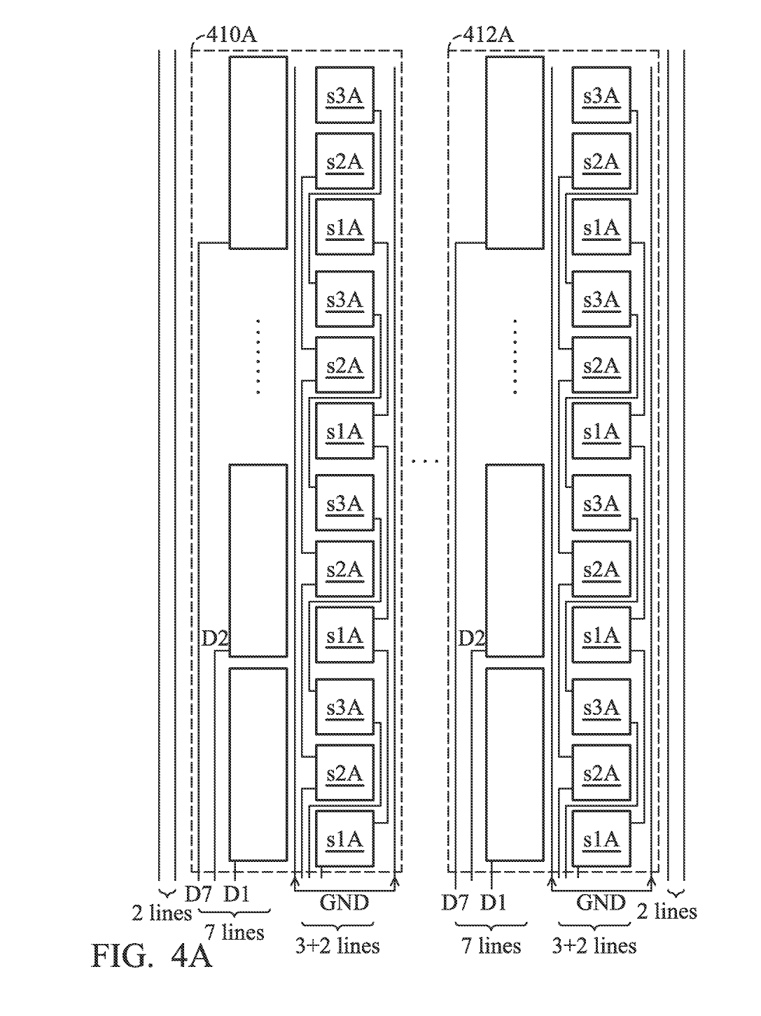

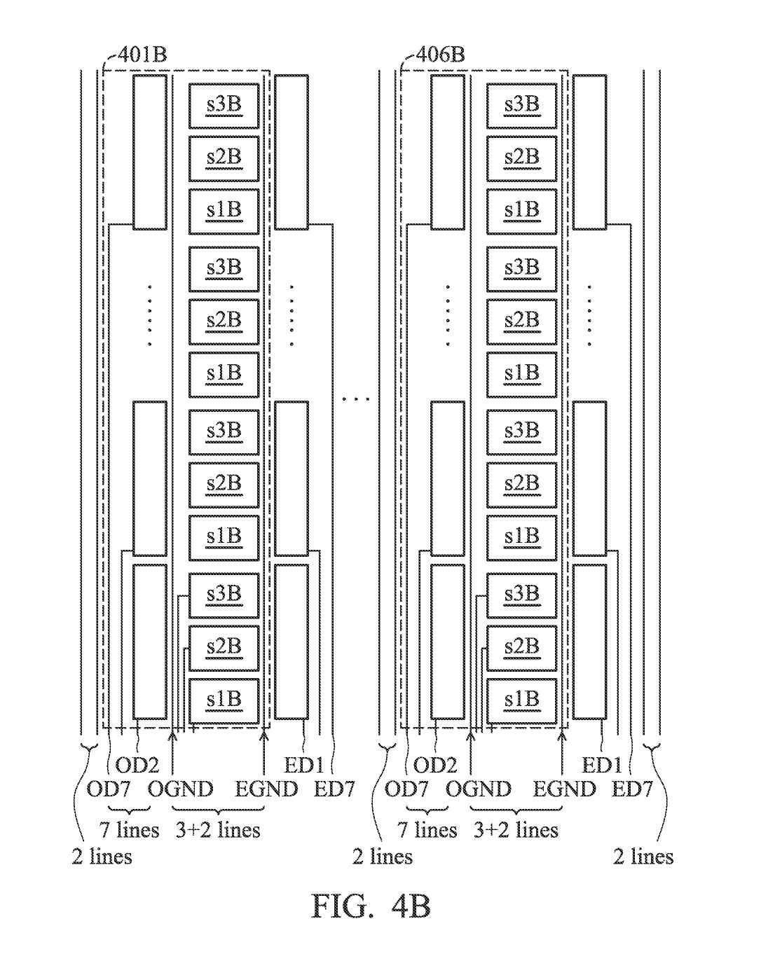

FIG. 4A is a diagram of a conventional sensing array. FIG. 4B is a diagram of the sensing array in accordance with another embodiment of the invention. The conventional sensing array 400A shown in FIG. 4A comprises 12 sets of sensing electrodes (e.g. 401A˜412A) and two ground lines at the left side and right side. Each sensing electrode comprises 7 Tx electrodes (e.g. D1˜D7) and corresponding Rx electrode array (e.g. 3 sets of Rx electrodes S1A˜S3A), and there are two ground lines at each side in each set of Rx electrodes. Accordingly, the total number of touch control output pins can be derived as (7+3+2)*12+2*2=148 pins.

The conventional sensing array 400A shown in FIG. 4A can be implemented by the sensing array 400B shown in FIG. 4B. As illustrated in FIG. 4B, the sensing array 400B comprises 6 sets of sensing electrodes (e.g. 401B˜406B) and two ground lines at the left side and right side. Each sensing electrode comprises 7 Tx electrodes (e.g. OD1˜OD7 or ED1˜ED7) and corresponding Rx electrode array (e.g. 3 sets of Rx electrodes S1B˜S3B), and there are two ground lines at both sides in each set of Rx electrodes (e.g. OGND and EGND for the odd isolation path and even isolation path). It should be noted that every two neighboring Tx electrodes can share the Rx electrode between them by the alternately switched control paths. Accordingly, the total number of touch control output pins can be derived as (7+3+2)*6+2*2+7=83 pins. It should be noted that the number of sensing electrodes in FIG. 4A and FIG. 4B are for description only, and different numbers of sensing electrodes can be used in the invention according to practical requirements. Obviously, compared with conventional sensing electrodes, the number of touch control output pins can be significantly reduced using the sensing electrodes with alternately switched control paths in the invention.

It should be noted that the layout of the sensing electrodes in the aforementioned embodiments are for description only, and those skilled in the art will appreciate that the disclosed layout of the sensing electrodes can be implemented using other layouts, thereby reducing the total number of touch control output pins by alternately switched control paths.

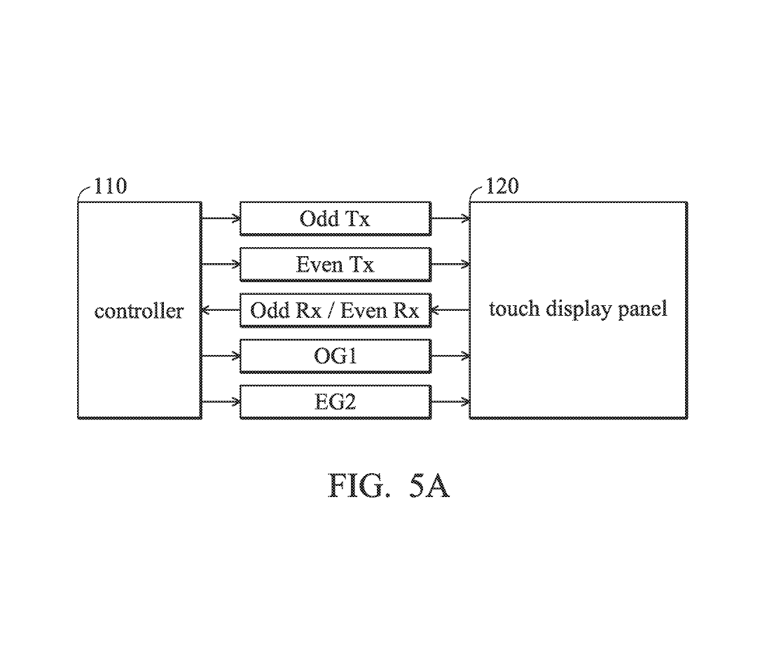

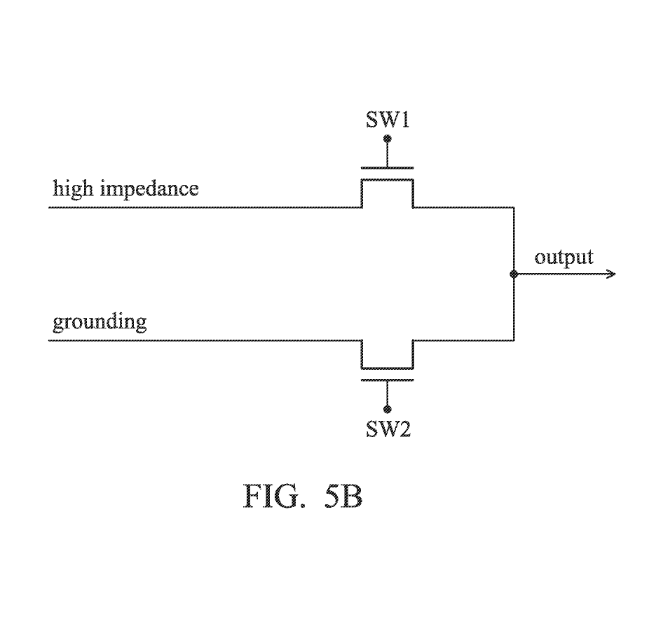

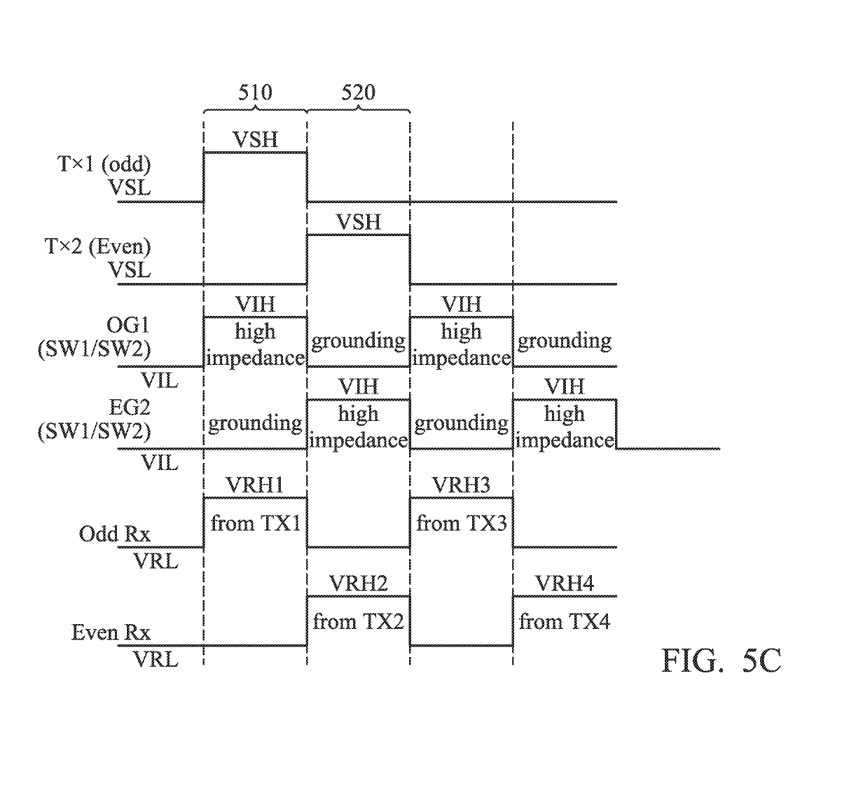

FIG. 5A is a diagram of the detailed control paths in accordance with the embodiment of FIG. 3. FIG. 5A illustrates various paths in each Tx electrode and Rx electrode of the sensing electrodes controlled by the controller 110 shown in FIG. 3, such as an odd Tx electrode path (Odd Tx), an even Tx electrode path (Even Tx), an odd Rx electrode path (Odd Rx), an even Rx electrode path (even Rx), an odd isolation path (OG1), and an even isolation path (EG2). FIG. 5B is a diagram of the isolation paths in accordance with the embodiment of FIG. 5A. The odd isolation path (OG1) and the even isolation path (EG2) can be implemented by the circuits shown in FIG. 5B. For example, the switch SW1 is used to turn on/off the high impedance, and the switch SW2 is used to turn on/off the Rx electrode. Only one of the switches SW1 and SW2 will be closed (activated), and the corresponding state (e.g. high impedance or shielding) of the activated switch will be the output of the isolation path.

FIG. 5C is a diagram of the control timing of each path in accordance with the embodiment of FIG. 5A. The control timing of each path in FIG. 5A is shown in FIG. 5C, wherein the interval between every two neighboring vertical lines is the display time of a frame. As illustrated in FIG. 5C, the voltages VSH and VSL are regarded as a high logic state and a low logic state in the Tx electrode path, respectively. The voltages VRH1˜VRH4 and VRL are regarded as the high logic state and the low logic state in the Rx electrode path, respectively. For example, during the internal 510, the odd-numbered Tx electrodes are charged via the odd Tx electrode path (Odd Tx). Meanwhile, the odd isolation path OG1 is coupled to high impedance and the even isolation path EG2 is coupled to the ground, and the odd Rx electrode path (Odd Rx) are activated to receive touch signals from the Tx electrode TX1. During the internal 520, the even-numbered Tx electrodes are charged via the even Tx electrode path (Even Tx). Meanwhile, the even isolation path EG2 is coupled to high impedance and the odd isolation path OG1 is coupled to the ground, and the even Rx electrode path (Even Rx) are activated to receive the touch signal from the Tx electrode Tx2. Similarly, the odd control path and even control path are switched alternately in the subsequent frames.

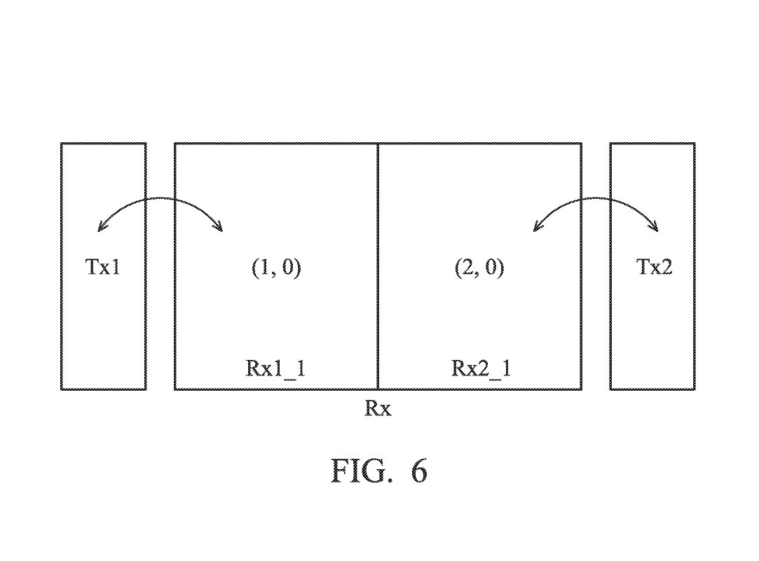

FIG. 6 is a diagram illustrating determining a touch position according to the detection signal from the sensing electrodes in accordance with an embodiment of the invention. The controller 110 may determine which Rx electrode has changes of the capacitance values according to the configurations of different paths. For example, as shown in FIG. 6, the x coordinate of the Tx electrode Tx 1 is 1, and the x coordinate of the Tx electrode Tx 2 is 2, and the y coordinate of both the Tx electrodes Tx 1 and Tx2 is 0. The controller 110 may determine whether the capacitance value changes in the first portion Rx1_1 or the second portion Rx2_1 of the Rx electrode Rx. Since the direction from the Tx electrode Tx 1 to the first portion Rx1_1 and the direction from the Tx electrode Tx2 to the second portion Rx2_1 are different, the controller 110 may calculate the touch position using a weighted average calculation. For example, given that the raw data detected by the first portion Rx1_1 of the Rx electrode is R1:1 and the weighting factor is set to 1, the controller 110 may calculate the x coordinate of the touch position as (x1*R1+x2*R2)/(weighting factor)=(1*1+2*0)/1=1, where x1 denotes the x coordinate of the Tx electrode Tx1 ; x2 denotes the x coordinate of the Tx electrode Tx 2; R1 denotes the detected raw data by the first portion Rx1_1; and R2 denotes the detected raw data by the second portion Rx2_1. Accordingly, the controller 110 may determine that the coordinates of the touch position are (1, 0). It should be noted that the relative position between the Tx electrodes and Rx electrodes can be changed based on different layouts, and the controller 110 may calculate the corresponding touch position according to the detection value from different portion of each Rx electrode in a similar way.

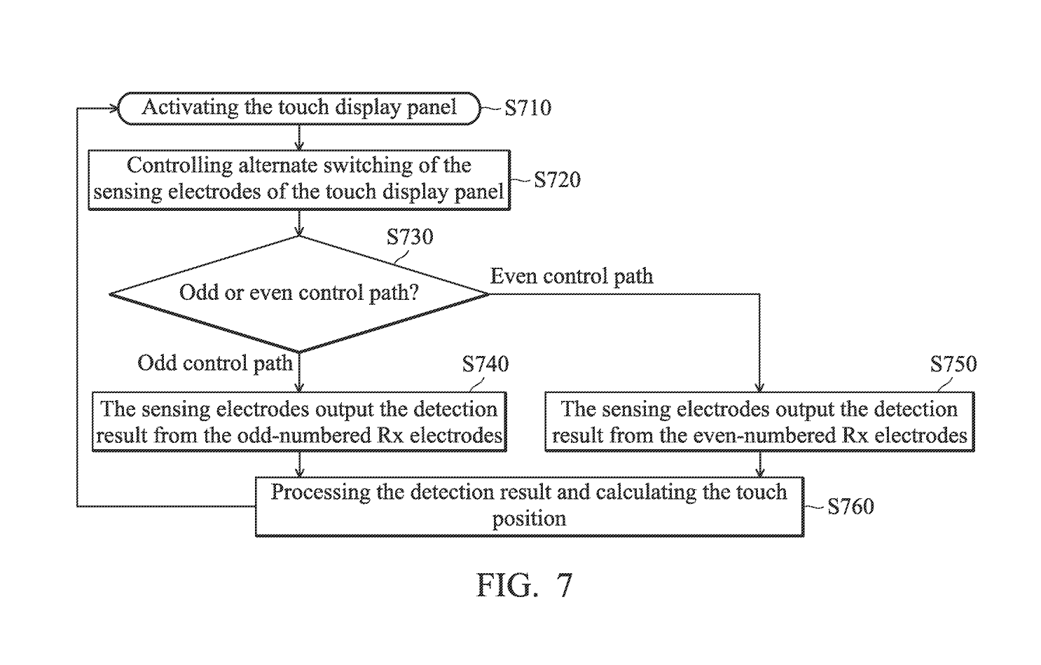

FIG. 7 is a flow chart of a touch display detection method in accordance with an embodiment of the invention. Referring to FIG. 1 and FIG. 7, in step S710, the controller 110 activates the touch display panel 120. In step S720, the controller 110 controls alternate switching of the sensing electrodes of the touch display panel 120, such as controlling the odd-numbered and even-numbered Tx electrodes and Rx electrodes to couple to the ground or high impedance. In step S730, the controller 110 determines whether the current control path is the odd control path or the even control path. If the odd control path is determined, the sensing electrodes output the detection result from the odd-numbered Rx electrodes (step S740). If the even control path is determined, the sensing electrodes output the detection result from the even-numbered Rx electrodes (step S750). In step S760, the controller 110 processes the detection result and calculates the touch position, and then step S710 is performed.

While the invention has been described by way of example and in terms of the preferred embodiments, it is to be understood that the invention is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A touch display apparatus, comprising:
a touch display panel, comprising a plurality of sensing electrodes, wherein the plurality of sensing electrodes comprise a plurality of transmitting (Tx) electrodes and a plurality of receiving (Rx) electrodes; and
a controller, configured to control the touch display panel,
wherein the controller alternately switches the Tx electrodes and the Rx electrodes to couple to the ground or high impedance using a first control path and a second control path, wherein the first control path controls the odd-numbered portion of the Tx electrodes and Rx electrodes, and the second control path controls the even-numbered portion of the Tx electrodes and Rx electrodes.

2. The touch display apparatus as claimed in claim 1, wherein the Tx electrodes and the Rx electrodes are arranged in alternate permutation.

3. The touch display apparatus as claimed in claim 1, wherein every two neighboring Tx electrodes of the Tx electrodes share the Rx electrode between them.

4. The touch display apparatus as claimed in claim 1, wherein the controller further determines whether a current control path is the first control path or the second control path,
if the first control path is determined, the sensing electrodes output a detection result from the odd-numbered portion of the Rx electrodes;
if the second path is determined, the sensing electrodes output a detection result from the even-numbered portion of the Rx electrodes;
wherein the controller further processes the detection result to calculate a touch position on the touch display apparatus.

5. A touch display detection method, for use in a touch display apparatus, wherein the touch display apparatus comprises a controller and a plurality of sensing electrodes, and the plurality of sensing electrodes comprise a plurality of transmitting (Tx) electrodes and a plurality of receiving (Rx) electrodes, the method comprising:
utilizing the controller to control the sensing electrodes; and
alternately switching the Tx electrodes and the Rx electrodes to couple to the ground or high impedance using a first control path and a second control path.

6. The method as claimed in claim 5, wherein the Tx electrodes and the Rx electrodes are arranged in alternate permutation.

7. The method as claimed in claim 5, wherein every two neighboring Tx electrodes of the Tx electrodes share the Rx electrode between them.

8. The method as claimed in claim 5, wherein the first control path controls the odd-numbered portion of the Tx electrodes and Rx electrodes, and the second control path controls the even-numbered portion of the Tx electrodes and Rx electrodes.

9. The method as claimed in claim 8, further comprising:
determining whether a current control path is the first control path or the second control path;
if the first control path is determined, utilizing the sensing electrodes to output a detection result from the odd-numbered portion of the Rx electrodes;
if the second path is determined, utilizing the sensing electrodes to output a detection result from the even-numbered portion of the Rx electrodes; and
processing the detection result to calculate a touch position on the touch display apparatus.
